(19) United States
(12) Patent Application Publication
(10) Pub. No.: US 2026/0071010 A1
(43) Pub. Date: Mar. 12, 2026

(54) RHEOLOGY MODIFYING OF POLYMERS WITH A RADICAL INITIATOR AND THIOURETHANE

(71) Applicant: BASF SE, Ludwigshafen Am Rhein (DE)

(72) Inventors: Michèle Gerster, Basel (CH); Daniel Mueller, Kaisten (CH); Raphael Dabbous, Kaisten (CH); Sebastien Villeneuve, Kaisten (CH); Wiebke Wunderlich-Wippert, Kaisten (CH); Heinz Herbst, Kaisten (CH)

(73) Assignee: BASF SE, Ludwigshafen Am Rhein (DE)

(21) Appl. No.: 19/107,922

(22) PCT Filed: Aug. 29, 2023
(86) PCT No.: PCT/EP2023/073715

§ 371 Date: Feb. 28, 2025

(30) Foreign Application Priority Data
Sep. 7, 2022 (EP) 22194366.5

(51) Int. Cl. C08F 8/34

(52) U.S. Cl. CPC C08F 8/34; C08F 2810/10

(57) ABSTRACT

A method modifies the rheology of a polymeric material through incorporation in the polymeric material a modifier blend having a) a radical initiator selected from peroxides, carbon-based radical generators, bis-azo compounds, or stable nitroxyl compounds, and b) thiourethane of the formula (1). A modified polymeric material is obtainable by incorporating in the polymeric material the modifier blend.

The present invention relates to a method for modifying the rheology of a polymeric material comprising the step of incorporating in the polymeric material a modifier blend comprising a) a radical initiator selected from peroxides, carbon-based radical generators, bis-azo compounds, or stable nitroxyl compounds, and b) thiourethane of the formula (1). The invention also relates to a modified polymeric material obtainable by incorporating in the polymeric material the modifier blend; and to the modifier blend.

The controlled preparation of polymer types (polymer types having different molar masses, melt viscosities, densities, molar mass distributions, etc.) by customary compounding methods, for example by extrusion or injection molding, is a routine process employed by polymer manufacturers and polymer processors/compounders. The setting of the desired parameters, for example the melt viscosity, by means of this polymer process step is critically dependent on the controlled reactivity and mode of action of the additives employed. Free-radical formers, especially peroxides, are often used for modifying the melt viscosity and rheology of polymeric materials.

Various problems are known: High concentrations of radical initiators are required to provide the expected performance; the market and regulatory trends push to reduce the amounts of additives in general, e.g. to satisfy safety and sustainable requirements; especially peroxides are often hazardous, rather unstable, sensitive to heat, shock or friction, react easily, with the main concerns being fire and explosions hazards.

Due to the low decomposition temperatures of many free-radical formers, e.g. peroxides, which are generally below the customary temperatures of the polymer processing temperatures, the use of peroxides only allows to work within a restricted “processing temperature window”. Even though the industry has developed reliable processes to ensure their safe use, the need remains to optimize their performance as free-Radical Initiators to promote the rheology modifications of polymeric materials.

The objects were solved by a method for modifying the rheology of a polymeric material comprising the step of incorporating in the polymeric material a modifier blend comprising
a) a radical initiator selected from peroxides, carbon-based radical generators, bis-azo compounds, or stable nitroxyl compounds, and
b) a thiourethane of the formula (1)

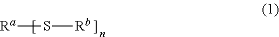

where
R^{a} is based on an organic isocyanate,
the radical(s) —S—R^{a} are introduced by reaction with isocyanate groups,
R^{b} is C₂-C₄₀ alkyl which is optionally substituted and/or interrupted, and
n is equal to or greater than 1.

The objects were solved by a modified polymeric material obtainable by incorporating in the polymeric material the modifier blend, where the modifier blend comprises
a) the radical initiator selected from peroxides, carbon-based radical generators, bis-azo compounds, or stable nitroxyl compounds, and
b) the thiourethane of the formula (1)

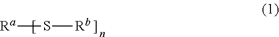

where
R^{a} is based on an organic isocyanate,
the radical(s) —S—R^{a} are introduced by reaction with isocyanate groups,
R^{b} is C₂-C₄₀ alkyl which is optionally substituted and/or interrupted, and
n is equal to or greater than 1.

The objects were solved by a modifier blend where the modifier blend comprises
a) the radical initiator selected from peroxides, carbon-based radical generators, bis-azo compounds, or stable nitroxyl compounds, and
b) the thiourethane of the formula (1)

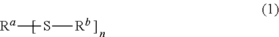

where
R^{a} is based on an organic isocyanate,
the radical(s) —S—R^{a} are introduced by reaction with isocyanate groups,
R^{b} is C₂-C₄₀ alkyl which is optionally substituted and/or interrupted, and
n is equal to or greater than 1.

The thiourethane is of the formula (1)

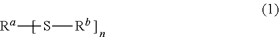

where
R^{a} is based on an organic isocyanate,
the radical(s) —S—R^{a} are introduced by reaction with isocyanate groups,
R^{b} is C₂-C₄₀ alkyl which is optionally substituted and/or interrupted, and
n is equal to or greater than 1.

The residue R^{a} is preferably based on an organic isocyanate, which is a cyclohexyl diisocyanate, methylenebis(cyclohexyl) diisocyanate, isophorone diisocyanate, phenyl diisocyanate, diphenylmethane diisocyanate or naphthyl diisocyanate each of which is unsubstituted or substituted by C₁-C₄alkyl or di(C₁-C₄alkyl)amino, or is C₄-C₂₀alkyl diisocyanate, or an oligomeric or polymeric product obtained by reaction of the above diisocyanates with themselves and/or with a polyol.

More preferably, the residue R^{a} is based on an organic isocyanate, which is a phenyl diisocyanate, diphenylmethane diisocyanate or naphthyl diisocyanate each of which is unsubstituted or substituted by C₁-C₄alkyl or di(C₁-C₄alkyl)amino, or an oligomeric or polymeric product obtained by reaction of the above diisocyanates with themselves and/or with a polyol.

It is highly preferred that R^{a} is based on an organic isocyanate, which is a phenyl diisocyanate which is unsubstituted or substituted by C₁-C₄alkyl, or an oligomeric or polymeric product obtained by reaction of the above diisocyanates with themselves and/or with a polyol.

It is most preferred that R^{a} is based on toluene-2,4-diisocyanate or toluene-2,6-diisocyanate, or an oligomeric or polymeric product obtained by reaction of the above diisocyanates with themselves and/or with a polyol.

Examples of products obtained by reaction of the above diisocyanates with themselves are the following reaction products of three equivalents of toluene-2,4-diisocyanate or toluene-2,6-diisocyanate, respectively, of the formula (2) and (3):

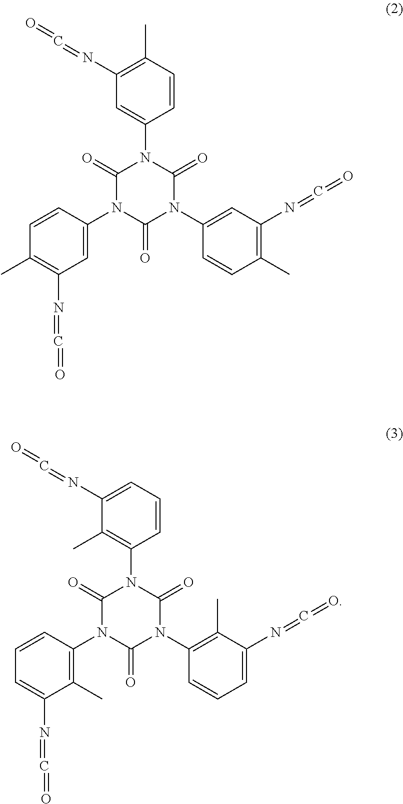 [SMILES: Cc1ccc(-n2c(=O)n(-c3ccc(C)c(N=C=O)c3)c(=O)n(-c3ccc(C)c(N=C=O)c3)c2=O)cc1N=C=O ; Cc1c(N=C=O)cccc1-n1c(=O)n(-c2cccc(N=C=O)c2C)c(=O)n(-c2cccc(N=C=O)c2C)c1=O]

Examples of products obtained by reaction of the above diisocyanates with polyols are the following reaction products of toluene-2,4-diisocyanate or toluene-2,6-diisocyanate, respectively, with a polyol of formula HO—CH₂—C(CH₂—OH)₂—CH₂—CH₃ of the formula (4) and (5):

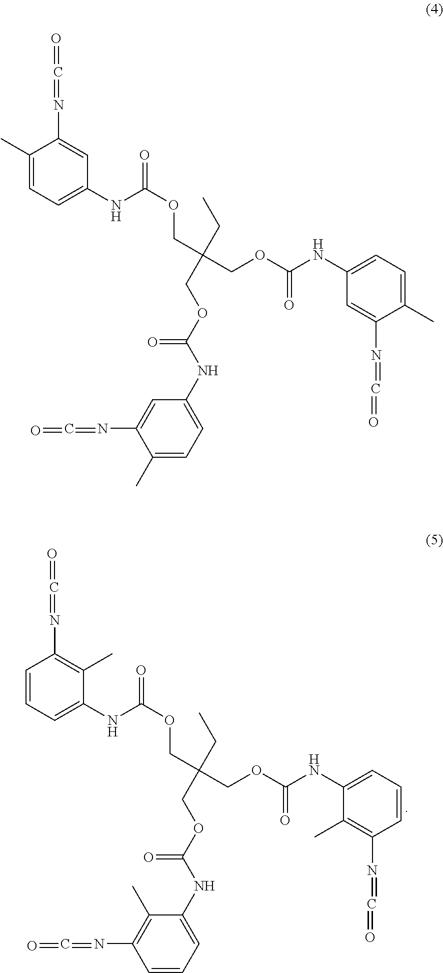

The polyol is preferably C₁-C₁₀ alkanol comprising two or more hydroxy groups, or a poly-C₂-C₁₀ alkylene glycol.

Preferred as C₁-C₁₀ alkanol for the polyols are those which are substituted by two to four, especially two or three, hydroxy groups. Particularly preferred is C₂-C₁₀ alkanol, especially C₂-C₆alkanol, which are correspondingly substituted by hydroxy groups. Highly preferred is the polyol of formula HO—CH₂—C(CH₂—OH)₂—CH₂—CH₃.

Preferred as poly-C₂-C₁₀alkylene glycol is poly-C₂-C₆ alkylene glycol, especially those of formula (7)

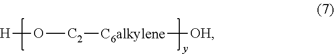

wherein y is a number from 2 to 600, especially from 2 to 200 and most preferably from 2 to 100. Highly preferred is a number from 2 to 50, especially 2 to 20. As to formula (7), preference is given to corresponding polyethylene glycol or polypropylene glycol. Preferably, the polyol is C₂-C₆ alkanol, which is substituted by two to four hydroxy groups, or poly-C₂-C₆ alkylene glycol, especially such of formula (7).

In case of a reaction of the diisocyanates with themselves, or the reaction of different types of diisocyanates with themselves, this can result in mixtures of different oligomers or polymers, and in case of the additional reaction with polyols even more complex mixtures can be obtained. Corresponding organic isocyanates are known or can be obtained according to known processes, for example from WO05/070987.

The residue R^{b} can, for example, be interrupted by —O—, —NH—, —S— and/or a carbonyl group. A possible substituent for R^{b} is —SH. Corresponding C₃-C₄₀alkyl, especially C₈-C₂₀alkyl, is preferred.

R^{b} is preferably C₂-C₄₀alkyl which is uninterrupted or interrupted by —O—, —NH—, —S— and/or a carbonyl group, especially by —O— and/or a carbonyl group.

Particularly preferably R^{b} is C₃-C₄₀alkyl, especially C₃-C₂₀alkyl, which is uninterrupted or interrupted by —O— and/or a carbonyl group.

n is equal to or greater than 1, such as from 1 to 10, preferably from 1 to 5, or in particular from 1 to 3. In another form n can be 1, 2, 3, 4 or 5.

The thiourethane can be obtainable by reaction of an organic isocyanate with thiols of the formula H—S—R^{b}, wherein for R^{b} the above definitions and preferences apply.

The radical(s) —S—R^{b} are introduced by reaction with isocyanate groups of the organic isocyanate, and in the reaction product are bonded as groups of formula (8)

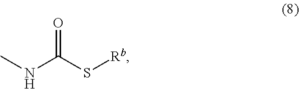

wherein R^{b} is as defined above.

In view of the above, the term “isocyanates functionalized with thio compounds” relates to corresponding thiourethanes.

The above process for the preparation of the thiourethane is usually carried out in presence of catalysts, like tertiary amines, for example triethylene diamine, dimethylpiperazine, dimethylethanolamine, 1,4-diazabicyclo[2.2.2]octane or 1,8-diazabicyclo[5,4,0]undec-7-ene, or with tin compounds as catalysts, for example dibutyl tin dilaurate. Triethylamine is preferred. The catalyst is, for example, used in an amount of 0.1 to 10 weight-%, based on the weight of the organic isocyanate. The reaction is usually carried out in presence of an organic solvent, like tetrahydrofuran or ethyl acetate, and at temperatures of, for example 30 to 80° C.

Suitable thiourethanes are of the formula (9), (10) or (11)

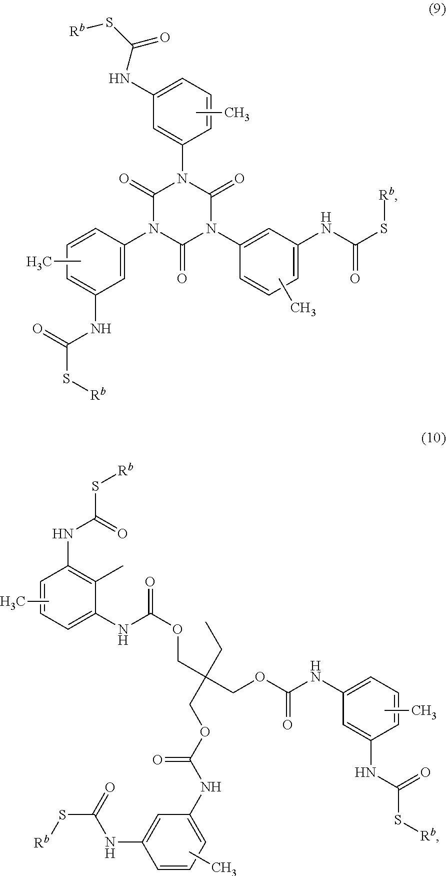

wherein in each of formulae (9) and (10) R^{b} is as defined above and for which the above preferences shall apply, or

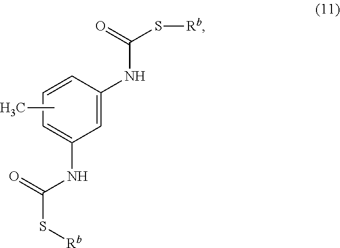

wherein for formula (11) R^{b} is C₃-C₄₀alkyl which is uninterrupted or interrupted by —O— and/or a carbonyl group, and for which the above preferences given for R^{b} shall apply. Preferred thiourethanes are compounds of formulae (9) and (10), especially those of formula (10).

In another form the preferred thiourethane is of the formula (12)

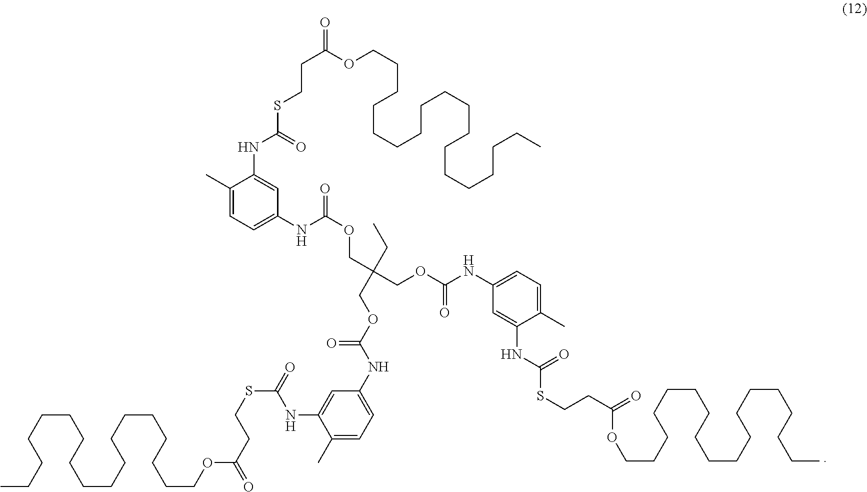 [SMILES: CCCCCCCCCCCCCCCCCCOC(=O)CCSC(=O)Nc1cc(NC(=O)OCC(CC)(COC(=O)Nc2ccc(C)c(NC(=O)SCCC(=O)OCCCCCCCCCCCCCCCCCC)c2)COC(=O)Nc2ccc(C)c(NC(=O)SCCC(=O)OCCCCCCCCCCCCCCCCCC)c2)ccc1C]

The radical initiator can be selected from peroxides, carbon-based radical generators, bis-azo compounds, or stable nitroxyl compounds, where peroxides and carbon-based radical generators are preferred. In one form the radical initiator is a peroxide. In another form the radical initiator is a carbon-based radical generator.

Suitable peroxides are organic or inorganic peroxides, preferably organic peroxides. Typical examples of suitable organic peroxides include 2,5-dimethyl-2,5-di(t-butylperoxy)hexane, 2,5-dimethyl-2,5-di(t-butylperoxy)hexyne-3, 3,6,6,9,9-pentamethyl-3-(ethyl acetate)-1,2,4,5-tetraoxy cyclononane, t-butyl hydroperoxide, hydrogen peroxide, dicumyl peroxide, t-butyl peroxy isopropyl carbonate, di-t-butyl peroxide, p-chlorobenzoyl peroxide, dibenzoyl diperoxide, t-butyl cumyl peroxide; t-butyl hydroxyethyl peroxide, di-t-amyl peroxide and 2,5-dimethylhexene-2,5-diperisononanoate, acetylcyclohexanesulphonyl peroxide, diisopropyl peroxydicarbonate, tert-amyl perneodecanoate, tert-butyl-perneodecanoate, tert-butylperpivalate, tert-amylperpivalate, bis(2,4-dichlorobenzoyl) peroxide, diisononanoyl peroxide, didecanoyl peroxide, dioctanoyl peroxide, dilauroyl peroxide, bis(2-methylbenzoyl) peroxide, disuccinoyl peroxide, diacetyl peroxide, dibenzoyl peroxide, tert-butyl per-2-ethylhexanoate, bis(4-chlorobenzoyl) peroxide, tert-butyl perisobutyrate, tert-butyl permaleate, 1,1-bis(tert-butylperoxy)-3,5,5-trimethylcyclohexane, 1,1-bis(tert-butylperoxy)cyclohexane, tert-butyl peroxyisopropyl carbonate, tert-butyl perisononaoate, 2,5-di-methylhexane 2,5-dibenzoate, tert-butyl peracetate, tert-amyl perbenzoate, tert-butyl per-benzoate, 2,2-bis(tert-butylperoxy)butane, 2,2-bis(tert-butylperoxy)propane, dicumyl peroxide, 2,5-dimethylhexane 2,5-di-tert-butylperoxid, 3-tert-butylperoxy-3-phenyl phthalide, di-tert-amyl peroxide, α,α′-bis(tert-butylperoxyisopropyl) benzene, 3,5-bis(tert-butylperoxy)-3,5-di-methyl-1 ,2-dioxolane, di-tert-butyl peroxide, 2,5-dimethylhexyne 2,5-di-tert-butyl peroxide, 3,3,6,6,9,9-hexamethyl-1 ,2,4,5-tetraoxacyclononane, p-menthane hydroperoxide, pinane hydroperoxide, diisopropylbenzene mono-α-hydroperoxide, cumene hydroperoxide or tert-butyl hydroperoxide.

In another form suitable peroxides are 2,5-dimethyl-2,5-bis(tert.-butylperoxy)hexane (DHBP), 2,5-dimethyl-2,5-bis(tert.-butylperoxy)hexyne-3 (DYBP), dicumyl-peroxide (DCUP), di-tert.-butyl-peroxide (DTBP), tert.-butyl-cumyl-peroxide (BCUP), bis(tert.-butylperoxyisopropyl)benzene (DIPP), 3,6,9-triethyl-3,6,9-trimethyl-1,4,7-triperoxonane, di(tert-butylperoxyisopropyl)benzene, dicetyl peroxydicarbonate, and tert-butyl monoperoxymaleate.

Preferred peroxides are 2,5-dimethyl-2,5-bis(tert.-butylperoxy)hexane (DHBP), tert.-butylcumyl-peroxide (BCUP) and 3,6,9-triethyl-3,6,9-trimethyl-1,4,7-triperoxonane, especially 2,5-dimethyl-2,5-bis(tert.-butylperoxy)hexane (DHBP) and 3,6,9-triethyl-3,6,9-trimethyl-1,4,7-triperoxonane. The peroxide is in particular 2,5-dimethyl-2,5-di(tert-butylperoxy)hexane.

Suitable bis-azo compounds are for example 2,2′-azobisisobutyronitrile, 2,2′-azobis(2-methylbutyronitrile), 2,2′-azobis(2,4-dimethylvaleronitrile), 2,2′-azobis(4-methoxy-2,4-dimethylvaleronitrile), 1,1′-azobis(1-cyclohexanecarbonitrile), 2,2′-azobis(isobutyramide) dihydrate, 2-phenylazo-2,4-dimethyl-4-methoxyvaleronitrile, dimethyl 2,2′-azobisisobutyrate, 2-(carbamoylazo)isobutyronitrile, 2,2′-azobis(2,4,4-trimethylpentane), 2,2′-azobis(2-methyl-propane), 2,2′-azobis(N,N′-dimethyleneisobutyramidine) as free base or hydrochloride, 2,2′-azobis(2-amidinopropane) as free base or hydrochloride, 2,2′-azobis{2-methyl-N-[1,1-bis(hydroxymethyl)ethyl]propionamide} or 2,2′-azobis{2-methyl-N-[1,1-bis(hydroxymethyl)-2-hydroxyethyl]propionamide}.

Suitable stable nitroxyl compounds are of the generic formula (13)

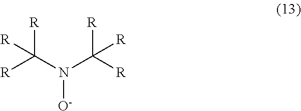

or are compounds that contain one or more groups of the formula (14)

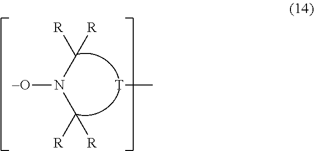

where each R is alkyl and T is a group required to complete a 5- or 6-membered ring. Two or more nitroxyl groups may be present in the same molecule by being linked through the T moiety as exemplified below where E is a linking group of the formula (15):

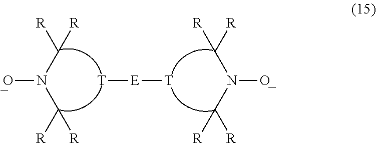

Suitable stable nitroxyl compounds include bis(1-oxyl-2,2,6,6-tetramethylpiperidin-4-yl) sebacate, 4-hydroxy-1-oxyl-2,2,6,6-tetramethylpiperidine, 4-ethoxy-1-oxyl-2,2,6,6-tetramethylpiperidine, 4-propoxy-1-oxyl-2,2,6,6-tetramethylpiperidine, 4-acetamido-1-oxyl-2,2,6,6-tetramethyl-piperidine, 1-oxyl-2,2,6,6-tetramethylpiperidine, 1-oxyl-2,2,6,6-tetramethylpiperidin-4-one, 1-oxyl-2,2,6,6-tetramethylpiperidin-4-yl acetate, 1-oxyl-2,2,6,6-tetramethylpiperidin-4-yl 2-ethyl-hexanoate, 1-oxyl-2,2,6,6-tetramethylpiperidin-4-yl stearate, 1-oxyl-2,2,6,6-tetramethyl-piperidin-4-yl benzoate, 1-oxyl-2,2,6,6-tetramethylpiperidin-4-yl 4-t-butyl-benzoate, bis(1-oxyl-2,2,6,6-tetramethylpiperidin-4-yl) succinate, bis(1-oxyl-2,2,6,6-tetramethylpiperidin-4-yl) adipate, bis(1-oxyl-2,2,6,6-tetramethylpiperidin-4-yl) n-butylmalonate, bis(1-oxyl-2,2,6,6-tetramethylpiperidin-4-yl) phthalate, bis(1-oxyl-2,2,6,6-tetramethylpiperidin-4-yl) isophthalate, bis(1-oxyl-2,2,6,6-tetramethylpiperidin-4-yl) terephthalate, bis(-oxyl-2,2,6,6-tetramethyl-piperidin-4-yl) hexahydroterephthalate, N,N′-bis(1-oxyl-2,2,6,6-tetramethylpiperidin-4-yl)adipamide, N-(1-oxyl-2,2,6,6-tetramethylpiperidin-4-yl)caprolactam, N-(1-oxyl-2, 2,6,6-tetramethylpiperidinyljdodecylsuccinimide, 2,4,6-tris-[N-butyl-N-(1-oxyl-2,2,6,6-tetrame-thylpiperidin-4-yl)]-s-triazine, 4,4′-ethylenebis(1-oxyl-2,2,6,6-tetramethylpiperazin-3-one), 2-oxyl-1,1,3,3-tetramethyl-2-isobenzazole, 1-oxyl-2,2,5,5-tetramethylpyrrolidine, and N,N-bis-(1,1,3,3-tetramethylbutyl)nitroxide.

Suitable carbon-based radical generators are of the formula (16)

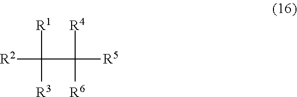

wherein each of R¹, R³, R⁴ and R⁶ independently is selected from the group consisting of hydrogen, substituted and unsubstituted straight, branched, and cyclic, hydrocarbons with 1 to 12 carbon atoms and substituted and unsubstituted aromatic hydrocarbons with κ to 12 carbon atoms, and each of R² and R⁵ independently is selected from the group consisting of substituted and unsubstituted straight, branched, and cyclic hydrocarbons with 1 to 12 carbon atoms and substituted and unsubstituted aromatic hydrocarbons with κ to 12 carbon atoms and wherein at least one of R¹, R², R³, R⁴, R⁵ and R⁶ is a substituted or unsubstituted aromatic hydrocarbon with 6 to 12 carbon atoms.

The carbon-based radical generators of formula (16) can have a symmetrical as well as an asymmetrical structure. Each of R² and R⁵ independently can be selected from a substituted or unsubstituted aryl group with 6 to 12 carbon atoms and each of R¹, R³, R⁴ and R⁶ independently is selected from the group consisting of hydrogen and C₁-C₆ alkyl groups.

In another embodiment, the carbon-based radical generators have the formula (17)

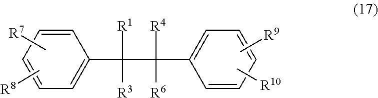

wherein each of R⁷, R⁸, R⁹ and R¹⁰ independently is selected from a group consisting of hydrogen atom, C1-6 alkyl groups, C1-2 alkoxy groups, a nitrile group and a halogen atom, and wherein each of R¹, R³, R⁴ and R⁶ independently is selected from group consisting of hydrogen and C1-6 alkyl groups.

In a still another embodiment, the carbon-based radical generator is selected from the group consisting of 2,3-dimethyl-2, 3-diphenylbutane, 2,3-dipropyl-2,3-diphenylbutane, 2, 3-dibutyl-2, 3-diphenylbutane, 2,3-dihexyl-2,3-diphenylbutane, 2-methyl-3-ethyl-2, 3-diphenylbutane, 2-methyl-2,3-diphenylbutane, 2, 3-diphenylbutane, 2,3-dimethyl-2,3-di-(p-methoxyphenyl)-butane, 2,3-dimethyl-2,3-di-(β-methylphenyl)-butane, 2,3-dimethyl-2-methylphenyl-3-(p-2′3′-dimethyl-3′-methylphenyl-butyl)-phenyl-butane, 3,4-dimethyl-3,4-diphenylhexane, 3,4-diethyl-3,4-diphenylhexane, 3,4-dipropyl-3,4-diphenylhexane, 4,5-dipropyl-4,5-diphenyloctane, 2,3-diisobutyl-2,3-diphenylbutane, 3,4-diisobutyl-3,4-diphenylhexane, 2,3-dimethyl-2,3-di-(p-t-butylphenyl)butane,5,6-dimethyl-5,6-diphenyldecane, 6,7-dimethyl-6,7-diphenyldodecane, 7,8-dimethyl-7,8-di(methoxyphenyl)-tetradecane, 2,3-diethyl-2, 3-diphenylbutane, 2,3-dimethyl-2,3-di(p-chlorophenyl)butane, 2,3-dimethyl-2,3-di(p-iodophenyl)butane, and 2,3-dimethyl-2,3-di(p-nitrophenyl) butane.

In another embodiment, the carbon-based radical generator is selected from the group consisting of 2,3-dimethyl-2,3-diphenylbutane and 3,4-dimethyl-3,4-diphenylhexane, preferably 2,3-dimethyl-2,3-diphenylbutane.

The radical initiator can be added to the polymeric material, such as the polyolefin, in an amount of 0.0001 to 5% by weight, especially 0.001 to 5% by weight and more preferably 0.01 to 5% by weight. In another form the radical initiator can be added to the polymeric material, such as the polyolefin, in an amount of 0.01 to 2% by weight, especially 0.01 to 1% by weight.

The thiourethane can be added to the polymeric material, such as the polyolefin, in an amount of 0.0001 to 5% by weight, especially 0.001 to 5% by weight and more preferably 0.01 to 5% by weight. In another form the radical initiator can be added to the polymeric material, such as the polyolefin, in an amount of 0.01 to 2% by weight, especially 0.01 to 1% by weight.

The weight ratio of the radical initiator to the thiourethane is usually from 1:2 to 30:1, preferably from 1:1 to 20:1, in particular 1.2:1 to 15:1. In another form the weight ratio of the radical initiator to the thiourethane can be from 1:1 to 10:1, preferably from 1.5:1 to 5:1, in particular 2:1 to 4:1.

In another form the weight ratio of the radical initiator to the thiourethane is from 1:2 to 30:1, preferably from 1:1 to 20:1, in particular 1.5:1 to 5:1.

In another form the polymeric material is a polyolefin, the radical initiator is a peroxide and the weight ratio of the radical initiator to the thiourethane is from 1:1 to 20:1.

In another form the polymeric material is a polyolefin, the radical initiator is a peroxide, where the peroxide is 2,5-dimethyl-2,5-bis(tert.-butyl-peroxy)hexane (DHBP), 2,5-dimethyl-2,5-bis(tert.-butyl-peroxy)hexyne-3 (DYBP), dicumyl-peroxide (DCUP), di-tert.-butyl-peroxide (DTBP), tert.-butyl-cumyl-peroxide (BCUP), bis(tert.-butylperoxyisopropyl)benzene (DIPP), 3,6,9-triethyl-3,6,9-trimethyl-1,4,7-triperoxonane, di(tert-butylperoxyisopropyl)benzene, dicetyl peroxydicarbonate, or tert-butyl monoperoxymaleate, and the weight ratio of the radical initiator to the thiourethane is from 1:1 to 20:1.

In another form the polymeric material is a polyolefin, the radical initiator is a carbon-based radical generators and the weight ratio of the radical initiator to the thiourethane is from 1:1 to 20:1.

In another form the polymeric material is a polyolefin, the radical initiator is a carbon-based radical generator, where the carbon-based radical generators have the formula (17), and the weight ratio of the radical initiator to the thiourethane is from 1:1 to 20:1.

In another form the polymeric material is a polyolefin, the radical initiator is a peroxide and the weight ratio of the radical initiator to the thiourethane is from 1.5:1 to 5:1.

In another form the polymeric material is a polyolefin, the radical initiator is a carbon-based radical generators and the weight ratio of the radical initiator to the thiourethane is from 1.5:1 to 5:1.

In another form the polymeric material is a polyolefin, the radical initiator is a carbon-based radical generator, where the carbon-based radical generators have the formula (17), and the weight ratio of the radical initiator to the thiourethane is from 1.5:1 to 5:1.

In another form the polymeric material is a polyolefin, the radical initiator is a peroxide, the weight ratio of the radical initiator to the thiourethane is from 1:1 to 20:1, and R^{a} is based on an organic isocyanate, which is a cyclohexyl diisocyanate, methylenebis(cyclohexyl) diisocyanate, isophorone diisocyanate, phenyl diisocyanate, diphenylmethane diisocyanate or naphthyl diisocyanate each of which is unsubstituted or substituted by C1-C4alkyl or di(C1-C4alkyl)amino, or is C4-C20alkyl diisocyanate, or an oligomeric or polymeric product obtained by reaction of the above diisocyanates with themselves and/or with a polyol.

In another form the polymeric material is a polyolefin, the radical initiator is a peroxide, where the peroxide is 2,5-dimethyl-2,5-bis(tert.-butyl-peroxy)hexane (DHBP), 2,5-dimethyl-2,5-bis(tert.-butyl-peroxy)hexyne-3 (DYBP), dicumyl-peroxide (DCUP), di-tert.-butyl-peroxide (DTBP), tert.-butyl-cumyl-peroxide (BCUP), bis(tert.-butylperoxyisopropyl)benzene (DIPP), 3,6,9-triethyl-3,6,9-trimethyl-1,4,7-triperoxonane, di(tert-butylperoxyisopropyl)benzene, dicetyl peroxydicarbonate, or tert-butyl monoperoxymaleate, the weight ratio of the radical initiator to the thiourethane is from 1:1 to 20:1, and R^{a} is based on an organic isocyanate, which is a cyclohexyl diisocyanate, methylenebis(cyclohexyl) diisocyanate, isophorone diisocyanate, phenyl diisocyanate, diphenylmethane diisocyanate or naphthyl diisocyanate each of which is unsubstituted or substituted by C1-C4alkyl or di(C1-C4alkyl)amino, or is C4-C20alkyl diisocyanate, or an oligomeric or polymeric product obtained by reaction of the above diisocyanates with themselves and/or with a polyol.

In another form the polymeric material is a polyolefin, the radical initiator is a carbon-based radical generators, the weight ratio of the radical initiator to the thiourethane is from 1:1 to 20:1, and R^{a} is based on an organic isocyanate, which is a cyclohexyl diisocyanate, methylenebis-(cyclohexyl) diisocyanate, isophorone diisocyanate, phenyl diisocyanate, diphenylmethane diisocyanate or naphthyl diisocyanate each of which is unsubstituted or substituted by C₁-C₄alkyl or di(C₁-C₄alkyl)amino, or is C₄-C₂₀alkyl diisocyanate, or an oligomeric or polymeric product obtained by reaction of the above diisocyanates with themselves and/or with a polyol.

In another form the polymeric material is a polyolefin, the radical initiator is a carbon-based radical generators, where the carbon-based radical generators have the formula (17), the weight ratio of the radical initiator to the thiourethane is from 1:1 to 20:1, and R^{a} is based on an organic isocyanate, which is a cyclohexyl diisocyanate, methylenebis(cyclohexyl) diisocyanate, isophorone diisocyanate, phenyl diisocyanate, diphenylmethane diisocyanate or naphthyl diisocyanate each of which is unsubstituted or substituted by C₁-C₄alkyl or di(C₁-C₄alkyl)amino, or is C₄-C₂₀alkyl diisocyanate, or an oligomeric or polymeric product obtained by reaction of the above diisocyanates with themselves and/or with a polyol.

In another form the polymeric material is a polyolefin, the radical initiator is a peroxide, the weight ratio of the radical initiator to the thiourethane is from 1:1 to 20:1, and R^{a} is based on an organic isocyanate, which is a phenyl diisocyanate which is unsubstituted or substituted by C₁-C₄alkyl, or an oligomeric or polymeric product obtained by reaction of the above diisocyanates with themselves and/or with a polyol.

In another form the polymeric material is a polyolefin, the radical initiator is a carbon-based radical generators, the weight ratio of the radical initiator to the thiourethane is from 1.5:1 to 5:1, and R^{a} is based on an organic isocyanate, which is a phenyl diisocyanate which is unsubstituted or substituted by C₁-C₄alkyl, or an oligomeric or polymeric product obtained by reaction of the above diisocyanates with themselves and/or with a polyol.

In another form the polymeric material is a polyolefin, the radical initiator is a peroxide, the weight ratio of the radical initiator to the thiourethane is from 1.5:1 to 5:1, and R^{a} is based on an organic isocyanate, which is a phenyl diisocyanate which is unsubstituted or substituted by C₁-C₄alkyl, or an oligomeric or polymeric product obtained by reaction of the above diisocyanates with themselves and/or with a polyol.

In another form the polymeric material is a polyolefin, the radical initiator is a carbon-based radical generators, the weight ratio of the radical initiator to the thiourethane is from 1:1 to 20:1, and R^{a} is based on an organic isocyanate, which is a phenyl diisocyanate which is unsubstituted or substituted by C₁-C₄alkyl, or an oligomeric or polymeric product obtained by reaction of the above diisocyanates with themselves and/or with a polyol.

In another form the polymeric material is a polyolefin, the radical initiator is a peroxide, the weight ratio of the radical initiator to the thiourethane is from 1:1 to 20:1, and the thiourethane is a compound of formulae (9) and (10).

In another form the polymeric material is a polyolefin, the radical initiator is a peroxide, where the peroxide is 2,5-dimethyl-2,5-bis(tert.-butyl-peroxy)hexane (DHBP), 2,5-dimethyl-2,5-bis(tert.-butyl-peroxy)hexyne-3 (DYBP), dicumyl-peroxide (DCUP), di-tert.-butyl-peroxide (DTBP), tert.-butyl-cumyl-peroxide (BCUP), bis(tert.-butylperoxyisopropyl)benzene (DIPP), 3,6,9-triethyl-3,6,9-trimethyl-1,4,7-triperoxonane, di(tert-butylperoxyisopropyl)benzene, dicetyl peroxydicarbonate, or tert-butyl monoperoxymaleate, the weight ratio of the radical initiator to the thiourethane is from 1:1 to 20:1, and the thiourethane is a compound of formulae (9) and (10).

In another form the polymeric material is a polyolefin, the radical initiator is a carbon-based radical generators, the weight ratio of the radical initiator to the thiourethane is from 1:1 to 20:1, and the thiourethane is a compound of formulae (9) and (10).

In another form the polymeric material is a polyolefin, the radical initiator is a carbon-based radical generator, where the carbon-based radical generators have the formula (17), the weight ratio of the radical initiator to the thiourethane is from 1:1 to 20:1, and the thiourethane is a compound of formulae (9) and (10).

In another form modifier blend comprises the radical initiator selected from peroxides and the thiourethane where R^{a} is based on an organic isocyanate, which is a phenyl diisocyanate which is unsubstituted or substituted by C1-C4alkyl, or an oligomeric or polymeric product obtained by reaction of the above diisocyanates with themselves and/or with a polyol, and the weight ratio of the radical initiator to the thiourethane is from 1:2 to 30:1, preferably from 1:1 to 20:1, in particular 1.5:1 to 5:1.

In another form modifier blend comprises the radical initiator selected from peroxides where the peroxide is 2,5-dimethyl-2,5-bis(tert.-butyl-peroxy)hexane (DHBP), 2,5-dimethyl-2,5-bis(tert.-butyl-peroxy)hexyne-3 (DYBP), dicumyl-peroxide (DCUP), di-tert.-butyl-peroxide (DTBP), tert.-butyl-cumyl-peroxide (BCUP), bis(tert.-butylperoxyisopropyl)benzene (DIPP), 3,6,9-triethyl-3,6,9-trimethyl-1,4,7-triperoxonane, di(tert-butylperoxyisopropyl)benzene, dicetyl peroxydicarbonate, or tert-butyl monoperoxymaleate, and the thiourethane, and the weight ratio of the radical initiator to the thiourethane is from 1:2 to 30:1, preferably from 1:1 to 20:1, in particular 1.5:1 to 5:1.

In another form modifier blend comprises the radical initiator selected from peroxides where the peroxide is 2,5-dimethyl-2,5-bis(tert.-butyl-peroxy)hexane (DHBP), 2,5-dimethyl-2,5-bis(tert.-butyl-peroxy)hexyne-3 (DYBP), dicumyl-peroxide (DCUP), di-tert.-butyl-peroxide (DTBP), tert.-butyl-cumyl-peroxide (BCUP), bis(tert.-butylperoxyisopropyl)benzene (DIPP), 3,6,9-triethyl-3,6,9-trimethyl-1,4,7-triperoxonane, di(tert-butylperoxyisopropyl)benzene, dicetyl peroxydicarbonate, or tert-butyl monoperoxymaleate, and the thiourethane where R^{a} is based on an organic isocyanate, which is a phenyl diisocyanate which is unsubstituted or substituted by C₁-C₄alkyl, or an oligomeric or polymeric product obtained by reaction of the above diisocyanates with themselves and/or with a polyol, and the weight ratio of the radical initiator to the thiourethane is from 1:2 to 30:1, preferably from 1:1 to 20:1, in particular 1.5:1 to 5:1.

In another form modifier blend comprises the radical initiator selected from peroxides where the peroxide is 2,5-dimethyl-2,5-bis(tert.-butyl-peroxy)hexane (DHBP), 2,5-dimethyl-2,5-bis(tert.-butyl-peroxy)hexyne-3 (DYBP), dicumyl-peroxide (DCUP), di-tert.-butyl-peroxide (DTBP), tert.-butyl-cumyl-peroxide (BCUP), bis(tert.-butylperoxyisopropyl)benzene (DIPP), 3,6,9-triethyl-3,6,9-trimethyl-1,4,7-triperoxonane, di(tert-butylperoxyisopropyl)benzene, dicetyl peroxydicarbonate, or tert-butyl monoperoxymaleate, and the thiourethane where the thiourethane is of the formula (9) or (10), and the weight ratio of the radical initiator to the thiourethane is from 1:2 to 30:1, preferably from 1:1 to 20:1, in particular 1.5:1 to 5:1.

In another form modifier blend comprises the radical initiator selected from carbon-based radical generators and the thiourethane where R^{a} is based on an organic isocyanate, which is a phenyl diisocyanate which is unsubstituted or substituted by C₁-C₄alkyl, or an oligomeric or polymeric product obtained by reaction of the above diisocyanates with themselves and/or with a polyol, and the weight ratio of the radical initiator to the thiourethane is from 1:2 to 30:1, preferably from 1:1 to 20:1, in particular 1.5:1 to 5:1.

In another form modifier blend comprises the radical initiator selected from carbon-based radical generators where the carbon-based radical generators have the formula (17), and the thiourethane where R^{a} is based on an organic isocyanate, which is a phenyl diisocyanate which is unsubstituted or substituted by C₁-C₄alkyl, or an oligomeric or polymeric product obtained by reaction of the above diisocyanates with themselves and/or with a polyol, and the weight ratio of the radical initiator to the thiourethane is from 1:2 to 30:1, preferably from 1:1 to 20:1, in particular 1.5:1 to 5:1.

In another form modifier blend comprises the radical initiator selected from carbon-based radical generators where the carbon-based radical generators have the formula (17), and the thiourethane where the thiourethane is of the formula (9) or (10), and the weight ratio of the radical initiator to the thiourethane is from 1:2 to 30:1, preferably from 1:1 to 20:1, in particular 1.5:1 to 5:1.

In a preferred from, if the radical initiator is selected from the peroxides, then the polymeric material, such as the polyolefin, is free of a compound of formula (18) or (19)

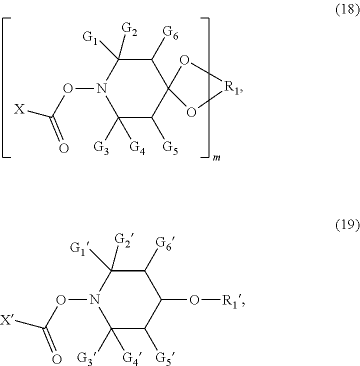

wherein
G₁, G₂, G₃ and G₄ are each independently of the other C₁-C₄alkyl, or G₁ and G₂ together or G₃ and G₄ together are pentamethylene;
G₁′, G₂′, G₃′ and G₄′ are each independently of the other C₁-C₄alkyl, or G₁′ and G₂′ together or G₃′ and G₄′ together are pentamethylene;
G₅, G₆, G₅′ and G₆′ are each independently of the other hydrogen or C₁-C₄alkyl; and
X and X′ are independently of each other hydrogen, C₁-C₁₃alkyl, C₂-C₁₃alkenyl, —O—C₁-C₁₃alkyl, —NH—C₁-C₁₃alkyl, —N(C₁-C₆alkyl)₂, phenyl, phenoxy or —NH-phenyl,
m is 1 or 2, and
when m is 1, R¹ is C₂-C₈alkylene or C₂-C₃hydroxyalkylene or C₄-C₃₆acyloxyalkylene, or,
when m is 2, R¹ is (—CH₂)₂C(CH₂—)₂, and
R₁′ is hydrogen, C₁-C₈alkyl, C₁-C₃hydroxyalkyl or a group of formula —(C═O)—C₁-C₄₀alkyl, or —O—R₁′ together with the —CH— group linking them are the group —(C═O)—.

The polymeric substrate can be a thermoplastic polymer, such as a polyolefin, polyester, polyamide, polyvinyl chloride, polyimide, polyacrylonitrile, polycarbonate or polystyrene polymer. Preferably, the polymeric substrate is a polyolefin.

Suitable polyolefins are polymers of monoolefins and diolefins, for example polypropylene, polyisobutylene, polybut-1-ene, poly-4-methylpent-1-ene, polyvinylcyclohexane, polyisoprene or polybutadiene, as well as polymers of cycloolefins, for instance of cyclopentene or norbornene, polyethylene (which optionally can be crosslinked), for example high density polyethylene (HDPE), high density and high molecular weight polyethylene (HDPE-HMW), high density and ultrahigh molecular weight polyethylene (HDPE-UHMW), medium density polyethylene (MDPE), low density polyethylene (LDPE), linear low density polyethylene (LLDPE), (VLDPE) and (ULDPE).

The polyolefins, preferably polyethylene and polypropylene, can be prepared by the following methods:
a) radical polymerisation (normally under high pressure and at elevated temperature).
b) catalytic polymerisation using a catalyst that normally contains one or more than one metal of groups IVb, Vb, VIb or VIII of the Periodic Table. These metals usually have one or more than one ligand, typically oxides, halides, alcoholates, esters, ethers, amines, alkyls, alkenyls and/or aryls that may be either π- or σ-coordinated. These metal complexes may be in the free form or fixed on substrates, typically on activated magnesium chloride, titanium(Ill) chloride, alumina or silicon oxide. These catalysts may be soluble or insoluble in the polymerisation medium. The catalysts can be used by themselves in the polymerisation or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

Examples of mixtures of polyolefins are mixtures of polypropylene with polyisobutylene, polypropylene with polyethylene (for example PP/HDPE, PP/LDPE) and mixtures of different types of polyethylene (for example LDPE/HDPE).

Examples of copolymers of monoolefins and diolefins with each other or with other vinyl monomers, are ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene like COC), ethylene/1-olefins copolymers, where the 1-olefin is generated in-situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EAA), LLDPE/EVA, LLDPE/EAA and alternating or random polyalkylene/carbon monoxide copolymers and mixtures thereof with other polymers, for example polyamides.

More preferably, the polyolefin is selected from the group consisting of polyethylene, like linear low density polyethylene, low density polyethylene, medium density polyethylene and high density polyethylene, and polyethylene copolymers and polypropylene homopolymers and polypropylene copolymers. Highly preferred is polyethylene or polypropylene, in particular polypropylene.

Also suitable as polymeric material is recycled plastics, which may be obtainable from domestic, commercial and industrial waste or from useful material collections. The recycled plastics may originate from separation and sorting, or from specific industrial sectors and return obligations, for example from the automobile industry, electrical/electronic industry, construction, agriculture and the textile industry, or from households and commerce (for example supermarkets). The recycled plastics can be single-material recycled plastics, for example from the polymer classes consisting of the polyolefins (polypropylene, high-density polyethylene, low-density polyethylene and polypropylene blends, and copolymers, such as PP/EPDM and PP/PE and polystyrene, or defined mixtures of recycled plastics.

The recycled plastics may also contain polyethylene terephthalate, polyamides, polycarbonate, cellulose acetate and polyvinylidene chloride. Secondary amounts, up to about 5%, of non-thermoplastics, for example polyurethanes, formaldehyde resins and phenolic resins, and typical amino resins, and also elastomers, for example vulcanized or unvulcanized rubber, may also be present. In certain plastic wastes, small amounts of foreign substances, for example, paper, pigments and adhesives, which are frequently difficult to remove, may also be present. These foreign substances may also originate from contact with diverse substances during use or processing, for example fuel residues, paint components, traces of metal, initiator residues or traces of water.

The step of incorporating in the polymeric material, such as the polyolefin, the modifier blend comprising the radical initiator and the thiourethane can be achieved by conventional methods, such as adding the modifier blend or its single components, namely the radical initiator and the thiourethane, to the polymeric material. The modifier blend or its single components, namely the radical initiator and the thiourethane, can be added to the polymeric material in the form of a liquid, a powder, granule or a masterbatch. The radical initiator and the thiourethane and optionally further additives may be added to the polymeric material either individually or mixed with one another. It is preferred that the radical initiator and the thiourethane are added together, preferably in the form of a masterbatch.

The radical initiator and the thiourethane and optionally further additives can be added to the polymeric material before, during or after polymerization or before or after crosslinking. The radical initiator and the thiourethane and optionally further additives can be incorporated into the polymeric material by known methods, for example before or during shaping or by applying the dissolved or dispersed respective compound to the polymeric material, if necessary with subsequent evaporation of the solvent.

The addition of the compounds to the polymeric material can be carried out in all customary mixing machines in which the polymer is melted and mixed with the compounds of the present composition and optionally further additives. Suitable machines are mixers, kneaders and extruders. The process is preferably carried out by adding the compounds during processing in an extruder. Particularly preferred processing machines are single-screw extruders, co-rotating and counter-rotating twin-screw extruders, planetary gear extruders, ring extruders or co-kneaders provided with at least one gas removal compartment to which a vacuum can be applied.

The polymers are subjected to an elevated temperature for a sufficient period of time for the molecular weight modification. In a preferred embodiment of the process of the present invention, a temperature range from about 150° C. to 340° C. is employed. In a preferred process variant, the temperature range from about 200° C. to 320° C., or 200° C. to 300° C., or 170° C. to 290° C., in particular about 180° C. to 280° C., is used.

The period of time necessary for modifying the molecular weight can vary as a function of temperature, the amount of material to be modified and the type of any extruder employed. It may range, for example, from about 10 seconds to 20 minutes, in particular from 20 seconds to 10 minutes.

Examples of processing or transformation of the compositions according to the present invention are: Injection blow molding, extrusion, blow molding, rotomolding, in mold decoration (back injection), slush molding, injection molding, co-injection molding, forming, compression molding, pressing, film extrusion (cast film; blown film), fiber spinning, other fiber processing (woven, nonwoven, especially fiber melt-blown, spun-bond), drawing (uniaxial, biaxial), annealing, deep drawing, calendering, mechanical transformation, sintering, coextrusion, coating, lamination, crosslinking (radiation, peroxide, silane), vapor deposition, weld together, glue, thermoforming, pipe extrusion, profile extrusion, sheet extrusion; sheet casting, spin coating, strapping, foaming, recycling/rework, extrusion coating.

The materials processed according to this invention can be used in a wide variety of forms, for example as films, fibres (continuous or non-continuous), tapes, or moulded articles. Fibers, including bicomponent fibers, are preferred. Bicomponent fibers are meant to be fibers comprising at least two distinct polymeric domains a) and b) in intimate adherence along the length of the fibers. These can be of any shapes, and are not limited to a particular shape. Examples of such shapes are side-by-side; sheath-core, orange, and matrix and fibrils types. Preferred are sheath-core type bicomponent fibers and side-by-side type bicomponent fibers, especially sheath-core type bicomponent fibers.

Preferred articles are nonwoven fabrics which shall also include webs and shall mean a textile structure of individual fibers, filaments, or threads that are directionally or randomly oriented and bonded by friction, and/or cohesion and/or adhesion and/or mechanical process, as opposed to a regular pattern of mechanically inter-engaged fibers, i.e., it is not a woven or knitted fabric. Examples of nonwoven fabrics include melt-blown filaments, spun-bond continuous filament webs, carded webs, air-laid webs, and wet-laid webs. Suitable bonding methods include thermal bonding, chemical or solvent bonding, resin bonding, mechanical needling, hydraulic needling, stitch-bonding. Suitable articles made of the polymeric material are geotextiles, roofing, cables, films, filtration media, filter, diapers, sanitary napkins, panty liners, incontinence products for adults, protective clothing, surgical drapes, surgical gown, or surgical wear. The modification of the rheology of the polymeric material, such as the polyolefin, is often achieved by long chain branching, crosslinking or viscosity breaking. The modification of the rheology allows to improve
mechanical properties, like tensile strength, elongation, tear resistance;
barrier properties, especially in nonwovens (e.g. hydrohead, air permeability, filter properties);
processing properties (broader scope of suitable polymers, parameter adaptation, like thermobonding temperature in nonwovens);
recycling, because the adjustment of the melt viscosity of the recycled polymers can provide a recycled item with more homogeneous molecular weight (narrower MWD) and therefore better mechanical properties. In addition, the use of a vis-broken polymer can serve as processing aid or compatibilizer that also contributes to higher mechanical properties of recycled polymers. In addition, as the rheological quality of the recycled polymers is variable, the present invention enables to regulate the rheological response of the polymer so that one can have a more steady and controllable process.

Improved properties with respect to tensile strength and elongation are of importance for, for example, the manufacture of nonwoven fabrics, since their preparation involves multiple steps and improved tensile strength or elongation helps to let them better survive these steps. Importantly, higher tensile strength provides the producer of nonwoven fabrics with the option to e.g. reduce weight while keeping still good mechanical performance of the product.

A further important aspect is the processing safety in the course of the preparation of non-wovens. It is desired to run the process for the preparation of nonwoven fabrics under more moderate conditions at lower process temperature. In order to be able to do so, still good mechanical properties, like tensile strength and elongation, must be obtained at lower process temperature. This allows to reduce the process temperature. Furthermore, energy savings will be a secondary benefit.

The modifying of the rheology of the polymeric materials usually means a lowering of the molecular weight (e.g. by degradation of the polymeric material) or an increase in the molecular weight (e.g. by crosslinking or branching of the polymeric material). The modified rheology is usually determined by analyzing the melt flow index (MFI), such as according to EN ISO 133, e.g. at 230° C. with 2.16 kg.

The modification usually means that the rheology (e.g. as determined with the MFI) of the polymeric material, such as the polyolefin, comprising the modifier blend with a certain amount of the radical initiator has increased or decreased (preferably the MFI has increased) by at least 1, 3, 5, 10, 20, 30, 40, or 50% based on the rheology of the same polymeric material which has only the radical initiator (but not the thiourethane) in said certain amount.

The polymeric material may additionally also contain various conventional additives, for example antioxidants, UV absorbers and light stabilizers, metal deactivators, phosphites and phosphonites, hydroxylamines, nitrones, thiosynergists, peroxide scavengers, polyamide stabilizers, basic co-stabilizers, nucleating agents, fillers and reinforcing agents, benzofuranones and indolinones, or other additives such as plasticisers, lubricants, emulsifiers, pigments, rheology additives, catalysts, flow-control agents, optical brighteners, flameproofing agents, antistatic agents and blowing agents.

### 1. Antioxidants

1.1. Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-meth-oxymethylphenol, nonylphenols which are linear or branched in the side chains, for example, 2,6-di-nonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.
1.2. Alkylthiomethylphenols, for example 2,4-dioctylthiomethyl-6-tert-butylphenol, 2,4-dioctyl-thiomethyl-6-methylphenol, 2,4-dioctylthiomethyl-6-ethylphenol, 2,6-di-dodecylthiomethyl-4-nonylphenol.
1.3. Hydroquinones and alkylated hydroquinones, for example 2,6-di-tert-butyl-4-methoxy-phenol, 2,5-di-tert-butylhydroquinone, 2,5-di-tert-amylhydroquinone, 2,6-diphenyl-4-octade-cyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.
1.4. Tocopherols, for example α-tocopherol, β-tocopherol, γ-tocopherol, 6-tocopherol and mixtures thereof (vitamin E).
1.5. Hydroxylated thiodiphenyl ethers, for example 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)-disulfide.
1.6. Alkylidenebisphenols, for example 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methy-lenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methyl-phenyl)-3-n-dodecylmercaptobutane, ethylene glycol bis[3,3-bis(3′-tert-butyl-4′-hydroxyphenyl)butyrate], bis(3-tert-butyl-4-hydroxy-5-methyl-phenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)butane, 2,2-bis(3,5-di-tert-butyl-4-hydroxyphenyl)propane, 2,2-bis(5-tert-butyl-4-hydroxy2-methylphenyl)-4-n-dodecylmercaptobutane, 1,1,5,5-tetra-(5-tert-butyl-4-hydroxy-2-methylphenyl)pentane.
1.7. O-, N- and S-benzyl compounds, for example 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate.
1.8. Hydroxybenzylated malonates, for example dioctadecyl-2,2-bis(3,5-di-tert-butyl-2-hy-droxybenzyl)malonate, di-octadecyl-2-(3-tert-butyl-4-hydroxy-5-methylbenzyl)malonate, di-dodecylmercaptoethyl-2,2-bis(3,5-di-tert-butyl-4-hydroxybenzyl)malonate, bis[4-(1,1,3,3-te-tramethylbutyl)phenyl]-2,2-bis(3,5-di-tert-butyl-4-hydroxybenzyl)malonate.
1.9. Aromatic hydroxybenzyl compounds, for example 1,3,5-tris(3,5-di-tert-butyl-4-hydroxy-benzyl)-2,4,6-trimethylbenzene, 1,4-bis(3,5-di-tert-butyl-4-hydroxybenzyl)-2,3,5,6-tetrame-thylbenzene, 2,4,6-tris(3,5-di-tert-butyl-4-hydroxybenzyl)phenol.
1.10. Triazine compounds, for example 2,4-bis(octylmercapto)-6-(3,5-di-tert-butyl-4-hydroxy-anilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine, 1,3,5-tris(3,5-dicyclohexyl-4-hydroxybenzyl)isocyanurate.
1.11. Benzylphosphonates, for example dimethyl-2,5-di-tert-butyl-4-hydroxybenzylphosphonate, diethyl-3,5-di-tert-butyl-4-hydroxybenzylphosphonate, dioctadecyl3,5-di-tert-butyl-4-hy-droxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid.
1.12. Acylaminophenols, for example 4-hydroxylauranilide, 4-hydroxystearanilide, octyl N-(3,5-di-tert-butyl-4-hydroxyphenyl)carbamate.
1.13. Esters of β-(3,5-di-tert-butyl-4-hydroxyphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hy-droxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.14. Esters of β-(5-tert-butyl-4-hydroxy-3-methylphenyl)propionic acid with mono- or polyhydric alcohols, e.g. with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis-(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane; 3,9-bis[2-{3-(3-tert-butyl-4-hydroxy-5-methylphenyl)propionyloxy}-1,1-dimethylethyl]-2,4,8,10-tetraoxaspiro[5.5]-undecane.
1.15. Esters of β-(3,5-dicyclohexyl-4-hydroxyphenyl)propionic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.16. Esters of 3,5-di-tert-butyl-4-hydroxyphenyl acetic acid with mono- or polyhydric alcohols, e.g. with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane.
1.17. Amides of β-(3,5-di-tert-butyl-4-hydroxyphenyl)propionic acid e.g. N,N′-bis(3,5-di-tert-butyl-4-hydroxyphenylpropionyl)hexamethylenediamide, N,N′-bis(3,5-di-tert-butyl-4-hydroxy-phenylpropionyl)trimethylenediamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, supplied by Addivant).

### 1.18. Ascorbic Acid (Vitamin C)

1.19. Aminic antioxidants, for example N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicy-clohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulfamoyl)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, bis(4-methoxyphenyl)amine, 2,6-di-tert-butyl-4-dimethylamino-methylphenol, 2,4′-diaminodiphenylmethane, 4,4′-diaminodiphenylmethane, N,N,N′,N′-tetra-methyl-4,4′-diaminodiphenylmethane, 1,2-bis[(2-methylphenyl)amino]ethane, 1,2-bis(phenyl-amino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyldiphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octyl-phenothiazines, N-allylphenothiazine, N,N,N′,N′-tetraphenyl-1,4-diaminobut-2-ene.

### 2. UV Absorbers and Light Stabilizers

2.1.2-(2′-Hydroxyphenyl)benzotriazoles, for example 2-(2′-hydroxy-5′-methylphenyl)-benzotriazole, 2-(3′,5′-di-tert-butyl-2′-hydroxyphenyl)benzotriazole, 2-(5′-tert-butyl-2′-hydroxyphe-nyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chloro-benzotriazole, 2-(3′-tert-butyl-2′-hydroxy-5′-methylphenyl)-5-chloro-benzotriazole, 2-(3′-sec-butyl-5′-tert-butyl-2′-hydroxyphenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis-(α,α-dimethylbenzyl)-2′-hydroxyphenyl)benzotriazole, 2-(3′-tert-butyl-2′-hydroxy-5′-(2-octyloxycarbonylethyl)phenyl)-5-chloro-benzotriazole, 2-(3′-tert-butyl-5′-[2-(2-ethylhexyloxy)-carbonylethyl]-2′-hydroxyphenyl)-5-chloro-benzotriazole, 2-(3′-tert-butyl-2′-hydroxy-5′-(2-methoxycarbonylethyl)phenyl)-5-chloro-benzotriazole, 2-(3′-tert-butyl-2′-hydroxy-5′-(2-meth-oxycarbonylethyl)phenyl)benzotriazole, 2-(3′-tert-butyl-2′-hydroxy-5′-(2-octyloxycarbonyl-ethyl)phenyl)benzotriazole, 2-(3′-tert-butyl-5′-[2-(2-ethylhexyloxy)carbonylethyl]-2′-hydroxy-phenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylene-bis[4-(1,1,3,3-tetramethylbutyl)-6-benzotriazole-2-ylphenol]; the transesterification product of 2-[3′-tert-butyl-5′-(2-methoxycarbonylethyl)-2′-hydroxyphenyl]-2H-benzotriazole with polyethylene glycol 300;

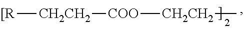

where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)-phenyl]benzotriazole; 2-[2′-hydroxy-3′-(1,1,3,3-tetramethylbutyl)-5′-(α,α-dimethylbenzyl)-phenyl]benzotriazole.
2.2.2-Hydroxybenzophenones, for example the 4-hydroxy, 4-methoxy, 4-decyloxy, 4-dodecyloxy, 4-benzyloxy, 4,2′,4′-trihydroxy and 2′-hydroxy-4,4′-dimethoxy derivatives.
2.3. Esters of substituted and unsubstituted benzoic acids, for example 4-tert-butylphenyl salicylate, phenyl salicylate, octylphenyl salicylate, dibenzoyl resorcinol, bis(4-tert-butylben-zoyl)resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.
2.4. Acrylates/Cinnamates, for example ethyl α-cyano-β,β-diphenylacrylate, isooctyl α-cyano-β,β-diphenylacrylate, methyl α-carbomethoxycinnamate, methyl α-cyano-β-methyl-p-methoxycinnamate, butyl α-cyano-β-methyl-p-methoxy-cinnamate, methyl α-carbomethoxy-p-methoxycinnamate, N-(p-carbomethoxy-p-cyanovinyl)-2-methylindoline, neopentyl tetra(α-cyano-β,β-diphenylacrylate. Cyanoacrylates may also be used as such compounds are given in EP 3587425.
2.5. Nickel compounds, for example nickel complexes of 2,2′-thio-bis[4-(1,1,3,3-tetramethyl-butyl)phenol], such as the 1:1 or 1:2 complex, with or without additional ligands such as n-butylamine, triethanolamine or N-cyclohexyldiethanolamine, nickel dibutyldithiocarbamate, nickel salts of the monoalkyl esters, e.g. the methyl or ethyl ester, of 4-hydroxy-3,5-di-tert-butylbenzylphosphonic acid, nickel complexes of ketoximes, e.g. of 2-hydroxy-4-methylphe-nylundecylketoxime, nickel complexes of 1-phenyl-4-lauroyl-5-hydroxypyrazole, with or without additional ligands.
2.6. Sterically hindered amines, for example carbonic acid bis(1-undecyloxy-2,2,6,6-tetramethyl-4-piperidyl)ester, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl) n-butyl-3,5-di-tert-butyl-4-hydroxybenzylmalonate, the condensate of 1-(2-hydroxyethyl)-2,2,6,6-tetramethyl-4-hydroxypiperidine and succinic acid, linear or cyclic condensates of N,N′-bis(2,2,6,6-tetramethyl-4-piperidyl)hexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, bis(1,2,2,6,6-pentamethylpiperidyl)-2-n-butyl-2-(2-hydroxy-3,5-di-tert-butylbenzyl)malonate, 3-n-octyl-7,7,9,9-tetramethyl-1,3,8-triazaspiro[4.5]decane-2,4-dione, bis(1-octyloxy-2,2,6,6-tetramethylpiperidyl)sebacate, bis(1-octyloxy-2,2,6,6-tetramethylpiperidyl)succinate, linear or cyclic condensates of N,N′-bis(2,2,6,6-tetramethyl-4-piperidyl)hexamethylenediamine and 4-morpholino-2,6-dichloro-1,3,5-triazine, the condensate of 2-chloro-4,6-bis(4-n-butylamino-2,2,6,6-tetramethylpiperidyl)-1,3,5-triazine and 1,2-bis(3-aminopropylamino)ethane, the condensate of 2-chloro-4,6-di-(4-n-butylamino-1,2,2,6,6-pentamethylpiperidyl)-1,3,5-triazine and 1,2-bis(3-aminopropylamino)ethane, 8-acetyl-3-dodecyl-7,7,9,9-tetramethyl-1,3,8-triazaspiro[4.5]decane-2,4-dione, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, a mixture of 4-hexadecyloxy- and 4-stearyloxy-2,2,6,6-tetramethylpiperidine, a condensate of N,N′-bis(2,2,6,6-tetramethyl-4-piperidyl)hexamethylenediamine and 4-cyclohexylamino-2,6-dichloro-1,3,5-triazine, a condensate of 1,2-bis(3-aminopropylamino)ethane and 2,4,6-trichloro-1,3,5-triazine as well as 4-butylamino-2,2,6,6-tetramethylpiperidine (CAS Reg. No. [136504-96-6]); a condensate of 1,6-hexanediamine and 2,4,6-trichloro-1,3,5-triazine as well as N,N-dibutylamine and 4-butylamino-2,2,6,6-tetramethylpiperidine (CAS Reg. No. [192268-64-7]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxo-spiro[4,5]decane, a reaction product of 7,7,9,9-tetramethyl-2-cycloundecyl-1-oxa-3,8-diaza-4-oxospiro-[4,5]decane and epichlorohydrin, 1,1-bis(1,2,2,6,6-pentamethyl-4-piperidyloxycarbonyl)-2-(4-methoxyphenyl)ethene, N,N′-bis-formyl-N,N′-bis(2,2,6,6-tetramethyl-4-piperidyl)hexamethylenediamine, a diester of 4-methoxymethylenemalonic acid with 1,2,2,6,6-pentamethyl-4-hydroxypiperidine, poly[methylpropyl-3-oxy-4-(2,2,6,6-tetramethyl-4-piperidyl)]siloxane, a reaction product of maleic acid anhydride-α-olefin copolymer with 2,2,6,6-tetramethyl-4-aminopiperidine or 1,2,2,6,6-pentamethyl-4-aminopiperidine, 2,4-bis[N-(1-cyclohexyloxy-2,2,6,6-tetramethylpiperidine-4-yl)-N-butylamino]-6-(2-hydroxyethyl)amino-1,3,5-triazine, 1-(2-hydroxy-2-methylpropoxy)-4-octadecanoyloxy-2,2,6,6-tetramethylpiperidine, 5-(2-ethylhexanoyl)-oxymethyl-3,3,5-trimethyl-2-morpholinone, Sanduvor® 3058 (Clariant; CAS Reg. No. 106917-31-1], 5-(2-ethylhexanoyl)oxymethyl-3,3,5-trimethyl-2-morpholinone, the reaction product of 2,4-bis[(1-cyclohexyloxy-2,2,6,6-piperidine-4-yl)butylamino]-6-chloro-s-triazine with N,N′-bis(3-ami-nopropyl)ethylenediamine), 1,3,5-tris(N-cyclohexyl-N-(2,2,6,6-tetramethylpiperazine-3-one-4-yl)amino)-s-triazine, 1,3,5-tris(N-cyclohexyl-N-(1,2,2,6,6-pentamethylpiperazine-3-one-4-yl)-amino)-s-triazine.
2.7. Oxamides, for example 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixture with 2-ethoxy-2′-ethyl-5,4′-di-tert-butoxanilide, mixtures of o- and p-methoxy-disubstituted oxanilides and mixtures of o- and p-ethoxy-disubstituted oxanilides.
2.8.2-(2-Hydroxyphenyl)-1,3,5-triazines, for example 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyl-oxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxy-propoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-di-methylphenyl)-1,3,5-triazine, 2,4-bis(4-[2-ethylhexyloxy]-2-hydroxyphenyl)-6-(4-methoxyphenyl)-1,3,5-triazine, 2,4-bis(4-biphenylyl)-6-[2-hydroxy-4-(2-ethylhexyloxy)phenyl]-1,3,5-triazine.
3. Metal deactivators, for example N,N′-diphenyloxamide, N-salicylal-N′-salicyloyl hydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bis(salicyl-oyl)oxalyl dihydrazide, N,N′-bis(salicyloyl)thiopropionyl dihydrazide.
4. Phosphites and phosphonites, for example triphenyl phosphite, diphenylalkyl phosphites, phenyldialkyl phosphites, tris(nonylphenyl) phosphite, trilauryl phosphite, trioctadecyl phosphite, distearylpentaerythritol diphosphite, tris(2,4-di-tert-butylphenyl) phosphite, diisodecyl pentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)pentaerythritol diphosphite, tristearyl sorbitol triphosphite, tetrakis(2,4-di-tert-butylphenyl) 4,4′-biphenylene diphosphonite, 6-isooctyloxy-2,4,8,10-tetra-tert-butyl-12H-dibenz[d,g]-1,3,2-dioxaphosphocin, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocin, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, phosphorous acid mixed 2,4-bis(1,1-dimethylpropyl)phenyl and 4-(1,1-dimethylpropyl)phenyl triesters (CAS: 939402-02-5), phosphorous acid triphenyl ester polymer with α-hydro-w-hydroxypoly[oxy(methyl-1,2-ethanediyl)]C₁₀-16-alkyl esters (CAS: 1227937-46-3), Doverphos LGP-12 (CAS:116265-68-1).

The following phosphites are especially preferred: Tris(2,4-di-tert-butylphenyl) phosphite, tris(nonylphenyl) phosphite, bis(2,4-di-cumylphenyl)pentaerythritol diphosphite,

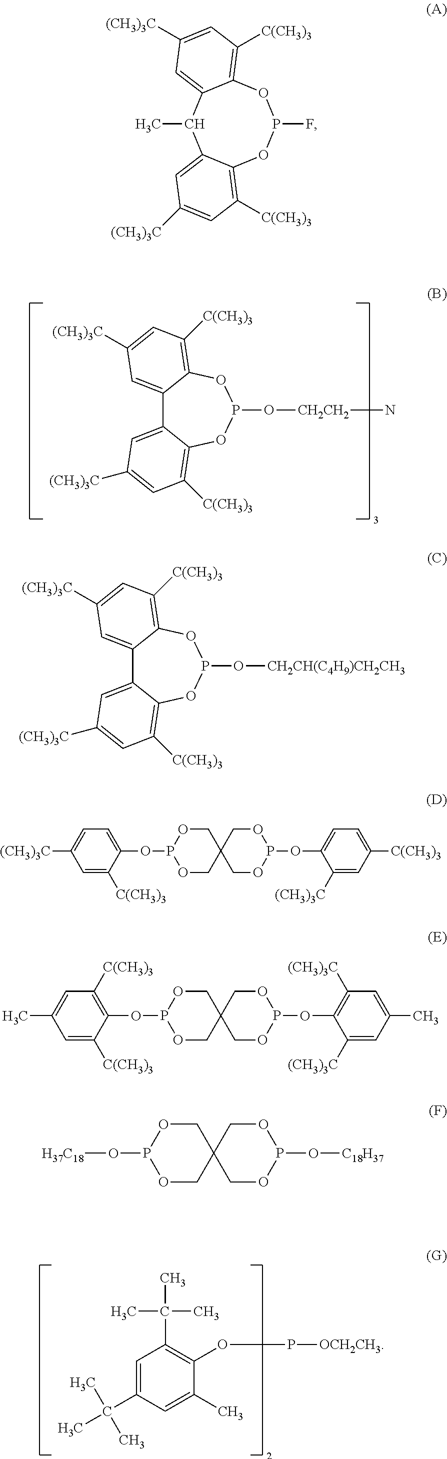

5. Hydroxylamines, for example N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine, N,N-dialkylhydroxylamine derived from hydrogenated tallow amine or derived from vegetable source.
6. Nitrones, for example, N-benzyl-alpha-phenylnitrone, N-ethyl-alpha-methylnitrone, N-octyl-alpha-heptylnitrone, N-lauryl-alpha-undecylnitrone, N-tetradecyl-alpha-tridecylnnitrone, N-hexadecyl-alpha-pentadecylnitrone, N-octadecyl-alpha-heptadecylnitrone, N-hexadecyl-alpha-heptadecylnitrone, N-ocatadecyl-alpha-pentadecylnitrone, N-heptadecyl-alpha-heptadecylnitrone, N-octadecyl-alpha-hexadecylnitrone, nitrone derived from N,N-dialkylhydroxylamine derived from hydrogenated tallow amine.
7. Thiosynergists, for example dilauryl thiodipropionate, dimistryl thiodipropionate, distearyl thiodipropionate or pentaerythritol tetrakis[3-(dodecylthio)propionate] or distearyl disulfide.
8. Peroxide scavengers, for example esters of β-thiodipropionic acid, for example the lauryl, stearyl, myristyl or tridecyl esters, mercaptobenzimidazole or the zinc salt of 2-mercaptobenzimidazole, zinc dibutyldithiocarbamate, dioctadecyl disulfide, pentaerythritol tetrakis(p-dodecylmercapto)propionate.
9. Polyamide stabilizers, for example copper salts in combination with iodides and/or phos-phorus compounds and salts of divalent manganese.
10. Basic co-stabilizers, for example melamine, polyvinylpyrrolidone, dicyandiamide, triallyl cyanurate, urea derivatives, hydrazine derivatives, amines, polyamides, polyurethanes, zeolithes, hydrotalcites, hydrocaluminates, zinc oxide, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate.
11. Nucleatinq agents, for example inorganic substances, such as talcum, metal oxides, such as titanium dioxide or magnesium oxide, phosphates including phosphate salts such as 2,2′-methylene-bis(4,6-di-tert-butylphenol) phosphate sodium salt, 2,2′-methylene-bis(4,6-di-tert-butylphenol) phosphate aluminium salt or 2,2′-methylene-bis(4,6-di-tert-butylphenol) phosphate lithium salt, carbonates or sulfates of, preferably, alkaline earth metals; organic compounds, such as mono- or polycarboxylic acids and the salts thereof, e.g. 4-tert-butylbenzoic acid, adipic acid, diphenylacetic acid, sodium succinate or sodium benzoate, 1,2-cyclohexane dicarboxylic acid calcium salt, bicyclo[2.2.1]heptane-2,3-dicarboxylic acid disodium salt; polymeric compounds, such as ionic copolymers (ionomers), triamino benzene derivatives such as 1,3,5-tris[2,2-dimethylpropionylamine]benzene, zinc glycerolate and nonytol derivatives. Especially preferred are 1,3:2,4-bis(3′,4′-dimethylbenzylidene)sorbitol, 1,3:2,4-di(paramethyl-dibenzylidene)sorbitol, and 1,3:2,4-di(benzylidene)sorbitol.
12. Fillers and reinforcinq agents, for example calcium carbonate, silicates, surface treated silica (as described e.g. in US-A-2007/60,697 and US-A-2009/111,918), glass fibres, glass beads, asbestos, talc, kaolin, mica, barium sulfate, metal oxides and hydroxides, carbon black, graphite, wood flour and flours or fibers of other natural products, synthetic fibers.
13. Other additives, for example plasticisers, lubricants, emulsifiers, pigments, rheology additives, catalysts, flow-control agents, optical brighteners, flameproofing agents, antistatic agents and blowing agents. Other additives may also include anti-blocking additives, which are used in films to reduce the negative adhesion of two polyethylene surfaces to one another which would otherwise result in difficulties separating the films. Further additives include slip additives, which are used to help the film surfaces slide over each other. Antifogging agents may also be added.
14. Benzofuranones and indolinones, for example those disclosed in U.S. Pat. Nos. 4,325,863; 4,338,244; 5,175,312; 5,216,052; 5,252,643; DE-A-4316611; DE-A-4316622; DE-A-4316876; EP-A-0589839, EP-A-0591102; EP-A-1291384 or 3-[4-(2-acetoxyethoxy)phenyl]-5,7-di-tert-butylbenzofuran-2-one, 5,7-di-tert-butyl-3-[4-(2-stearoyloxy-ethoxy)phenyl]benzofuran-2-one, 3,3′-bis[5,7-di-tert-butyl-3-(4-[2-hydroxyethoxy]phenyl)ben-zofuran-2-one], 5,7-di-tert-butyl-3-(4-ethoxyphenyl)benzofuran-2-one, 3-(4-acetoxy-3,5-di-methylphenyl)-5,7-di-tert-butylbenzofuran-2-one, 3-(3,5-dimethyl-4-pivaloyloxyphenyl)-5,7-di-tert-butylbenzofuran-2-one, 3-(3,4-dimethylphenyl)-5,7-di-tert-butylbenzofuran-2-one, 3-(2,3-dimethylphenyl)-5,7-di-tert-butylbenzofuran-2-one, 3-(2-acetyl-5-isooctylphenyl)-5-isooctyl-benzofuran-2-one, 5,7-ditert-butyl-3-[3,5-dimethyl-4-[(1,3,7,9-tetratert-butyl-5-methyl-5H-benzo[d][1,3,2]benzodioxaphosphocin-11-yl)oxy]phenyl]-3H-benzofuran-2-one. Suitable benzofuranones also include compounds identified in WO2015/121445 and WO2017/025431.

Preference is given to compositions which additionally contain a further additive selected from the group consisting of antioxidants, processing stabilisers, light stabilisers, UV absorbers, fillers, reinforcing agents, pigments, metal deactivators, plasticisers, lubricants, emulsifiers, rheology additives, catalysts, flow-control agents, optical brighteners, flameproofing agents, antistatic agents and blowing agents.

### EXAMPLES

ThioU: The thiourethane of the formula (12).
PER: 2,5-Dimethyl-2,5-di(tert-butylperoxy)hexane, commercially available as Enox 101, from Vesta Chemicals
DIC: 2,3-Dimethyl-2,3-diphenylbutane, commercially available from Acros Organics.

### Examples 1-8

The base stabilization (0.1% of Irganox® B 225 and 0.05% of calcium stearate) and the additives listed in Table 1 were added into a commercially available polypropylene powder (HA10XT from Polychim Industrie, France, melt flow index 3 g/10 min ASTM D1238) using a high-speed mixer (Mixaco Lab CM 12, Mixaco Maschinenbau, Germany). The mixture was extruded on a twin-screw extruder (Berstorff ZE25A x 47D, KraussMaffei Berstorff GmbH, Germany) at a temperature of Tmax=230° C. with a throughput of 4 kg/h and 100 rpm under N2. The resulting polymer strands were granulated in a water bath.

The melt flow index (MFI) was determined at 230° C. with 2.16 kg in a Göttfert MI Robo (Göttfert Werkstoff Prufmaschinen GmbH, Germany) in accordance to EN ISO 1133.

An increase in the MFI indicates vis breaking activity, respectively a controlled polypropylene chain degradation. The differences in MFI (“Delta MFI”, i.e. MFI of the additivated formulations versus MFI of the non-additivated reference formulation) are a measure for the different activities of the additives. The results are summarized in Tables 1a to 1d.

TABLE 1a

| | Additives | MFI | Delta MFI |
|---|---|---|---|
| Reference | — | 4.6 | 0.0 |
| Comparative Example 1 | 0.006% PER | 7.5 | 2.9 |
| Comparative Example 2 | 0.04% PER | 23.7 | 19.1 |
| Comparative Example 3 | 0.06% PER | 37.1 | 32.5 |
| Comparative Example 4 | 0.006% ThioU | 4.8 | 0.2 |
| Example 1 | 0.003% PER | 7.6 | 3.0 |
| | 0.003% ThioU | | |

The Comparative Examples 1-3 showed the known increase in MFI when increasing the peroxide concentration. The Comparative Example 4 showed that ThioU had nearly no influence on MFI when used without the peroxide. The Example 1 demonstrated that the Delta MFI of about 3 can be achieved with only 0.003% peroxide when combined with ThioU, whereas in Comparative Example 1 the double amount, namely 0.006% of peroxide were needed.

TABLE 1b

| | Additives | MFI | Delta MFI |
|---|---|---|---|
| Reference | — | 4.6 | 0.0 |
| Comparative Example 2 | 0.04% PER | 23.7 | 19.1 |
| Comparative Example 4 | 0.006% ThioU | 4.8 | 0.2 |
| Example 2 | 0.03% PER | 31.6 | 27.0 |
| | 0.01% ThioU | | |
| Example 4 | 0.034% PER | 33.0 | 28.4 |
| | 0.006% ThioU | | |
| Example 5 | 0.04% PER | 40.3 | 35.7 |
| | 0.006% ThioU | | |

TABLE 1c

| | Additives | MFI | Δ MFI |
|---|---|---|---|
| Reference | — | 4.6 | 0.0 |
| Comparative Example 3 | 0.06% PER | 37.1 | 32.5 |
| Comparative Example 4 | 0.006% ThioU | 4.8 | 0.2 |
| Example 3 | 0.054% PER | 49.2 | 44.6 |
| | 0.006% ThioU | | |

The Example 2, 3, 4 and 5 demonstrated that the Delta MFI can even be increased further when the peroxide was combined with ThioU.

TABLE 1d

| | Additives | MFI | Delta MFI |
|---|---|---|---|
| Reference | — | 4.6 | 0.0 |
| Comparative Example 4 | 0.006% ThioU | 4.8 | 0.2 |
| Comparative Example 5 | 0.04% DIC | 4.9 | 0.3 |
| Example 6 | 0.03% DIC | 6.2 | 1.6 |
| | 0.01% ThioU | | |
| Example 7 | 0.034% DIC | 5.7 | 1.1 |
| | 0.006% ThioU | | |
| Example 8 | 0.04% DIC | 5.9 | 1.3 |
| | 0.006% ThioU | | |

The Comparative Examples 4 and 5 showed the known low increase in MFI with DIC. The Examples 6-8 demonstrated that the Delta MFI can be clearly increased when combined with ThioU.

### Examples 9-10

The Examples 9-10 were made as described in Example 1, but instead of an extruding temperature of 230° C. a temperature of 270° C. was used. The results are summarized in Table 2.

TABLE 2

| | Additives | MFI | Delta MFI |
|---|---|---|---|
| Reference | — | 6.6 | 0.0 |
| Comparative Example 6 | 0.04% PER | 29.5 | 22.9 |
| Example 9 | 0.03% PER | 40.2 | 33.6 |
| | 0.01% ThioU | | |
| Example 10 | 0.034% PER | 41.1 | 34.5 |
| | 0.006% ThioU | | |

The Example 9 and 10 demonstrated that the Delta MFI can be increased when the peroxide was combined with ThioU.

### Examples 11-12

The Examples 11-12 were made as described in Example 1, but instead of an extruding temperature of 230° C. a temperature of 250° C. was used, and a different commercial polypropylene (Moplen HP561R ground from lyondellbasell, MFI 25 g/10 min ISO 1133-1) was used. The results are summarized in Tables 3a and 3b.

TABLE 3a

| | Additives | MFI | Delta MFI |
|---|---|---|---|
| Reference | — | 28.6 | 0 |
| Comparative Example 7 | 0.006% PER | 33.7 | 5.1 |
| Comparative Example 8 | 0.006% ThioU | 31.2 | 2.6 |
| Example 11 | 0.003% PER | 34.8 | 6.1 |
| | 0.003% ThioU | | |

The Example 11 demonstrated that the Delta MFI can be increased when the peroxide was combined with ThioU, even when the peroxide was used in lower concentration compared to Comparative Example 7.

TABLE 3b

| | Additives | MFI | Delta MFI |
|---|---|---|---|
| Reference | — | 28.6 | 0 |
| Comparative Example 9 | 0.006% DIC | 28.2 | −0.3 |
| Comparative Example 8 | 0.006% ThioU | 31.2 | 2.6 |
| Example 12 | 0.003% DIC | 30.8 | 2.1 |
| | 0.003% ThioU | | |

The Example 12 demonstrated that the Delta MFI can be increased when DIC was combined with ThioU, even when DIC was used in half the concentration compared to Comparative Example 9.

### Examples 13-14

### A) Preparation of the Masterbatches

A peroxide masterbatch was produced by adding 0.15% PER into a commercial polypropylene (Moplen HP 561R ground, MFI 25 from Lyondell Basell) via soaking. For this purpose, the polymer pellets were put into a round piston. The piston was preheated to 60° C. and afterwards the PER was added with the help of an eyedropper. The piston was closed and sealed with PTFE. The piston was placed on a rotation evaporator and the mixture was treated with continuous rotation for 3 hours.

The activator masterbatch was produced by mixing 0.15% of the ThioU into the same polypropylene powder (Moplen HP 561R) with the help of a high-speed mixer. In the following step, the mixture was compounded in a twin-screw extruder (Berstorff ZE 25AX47D) at 200° C.

### B) Preparation of the Bicomponent Nonwovens

Spunbond nonwovens were produced with polypropylene: Polypropylene Total 7059 (MFI 11, from TotalEnergies) in the core and Polypropylene PP 511A (MFI 25, from Sabic) in the sheath, with and without the additives in the core, on a 1 m wide Reicofil 4 line with a single beam having around 6800 holes per meter length. The holes had a diameter of 0.62 mm. Throughput per hole was set at 0.55 g/min. The line had a sheath-core configuration with 20% by weight of the polymer in the sheath and 80% by weight of the polymer in the core. The comparative fibers were prepared wherein both domains were free of the additive.

The nonwovens were produced with a fabric weight of 70 g/m² (line speed: 52 m/min). Target filament fineness was 1.7 dtex (dtex is a unit of measure for the linear mass density of fibers and is defined as the mass in grams per 10000 meters). The nonwovens were thermally bonded using an embossed roll set at 165° C. with a nip pressure set at 90 N/mm.

The additives given in the below Tables were added via their corresponding masterbatches as described above, with the weight % indicative of the total amount of the additive present in the masterbatch.

Further processing conditions are given below:
The extruder temperature is the temperature used for extrusion of the polypropylene or polypropylene/Additive blend on the Reicofil 4 line, which was set at 270° C. for the core and at 250° C. for the sheath in all examples.
The cabin pressure is the pressure in the cabin after and below the die, which was set at 4500 Pa in all examples.

### C) Evaluation of the Mechanical Properties

The mechanical properties of the nonwoven fabrics were determined according to DIN EN 29073-3 with a sample clamping length of 100 mm, sample width of 50 mm, advance (deformation speed) of 200 mm/min. Tensile Strength TD and Elongation TD are the corresponding maximum values measured in the direction perpendicular to the machine direction. Elongation MD are the corresponding maximum values measured in the machine direction. The results are summarized in Tables 4a and 4b.

TABLE 4a

| | | Tensile strength TD |
|---|---|---|
| | Additives | N/5 cm |
| Reference | — | 116.8 |
| Comparative Example 10 | 0.006% ThioU | 125.1 |
| Comparative Example 11 | 0.006% PER | 131.4 |
| Example 13 | 0.003% ThioU | 133.0 |
| | 0.003% PER | |

The Example 13 demonstrated that the tensile strength increased compared to Comparative Examples 10-11, even when lower or half the amount of PER was used.

TABLE 4b

| | | Elongation MD | Elongation TD |
|---|---|---|---|
| | Additives | % | % |
| Reference | — | 125.3 | 119.4 |
| Comparative | 0.006% ThioU | 133.0 | 129.4 |
| Example 12 | | | |
| Comparative | 0.006% PER | 147.5 | 129.1 |
| Example 13 | | | |
| Example 14 | 0.003% ThioU | 149.3 | 130.2 |
| | 0.003% PER | | |

The Example 14 demonstrated that the elongation increased compared to Comparative Examples 12-13, even when lower or half the amount of PER was used.

1. A method for modifying the rheology of a polymeric material, the method comprising:
incorporating in the polymeric material a modifier blend comprising
a) a radical initiator selected from a group consisting of a peroxide, a carbon-based radical generator, a bis-azo compound, and a stable nitroxyl compound, and
b) a thiourethane of formula (1) 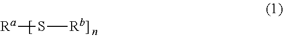
where
R^{a} is based on an organic isocyanate,
at least one radical —S—R^{a} is introduced by reaction with an isocyanate group,
R^{b} is a C₂-C₄₀ alkyl which is optionally substituted and/or interrupted, and
n is equal to or greater than 1.

2. The method according to claim 1, where a weight ratio of the radical initiator to the thiourethane is from 1:2 to 30:1.

3. The method according to claim 1, where the radical initiator is selected from a group consisting of a peroxide and a carbon-based radical generator.

4. The method according to claim 1, where the carbon-based radical generator is of formula (17) 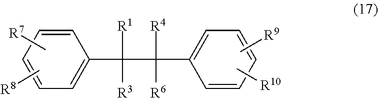
wherein each of R⁷, R⁸, R⁹ and R¹⁰ independently is selected from a group consisting of a hydrogen atom, a C1-6 alkyl group a C1-2 alkoxy, a nitrile group and a halogen atom, and wherein each of R¹, R³, R⁴ and R⁶ independently is selected from a group consisting of a hydrogen and a C1-6 alkyl group.

5. The method according to claim 1, where the peroxide is 2,5-dimethyl-2,5-bis(tert.-butyl-peroxy)hexane (DHBP), 2,5-dimethyl-2,5-bis(tert.-butyl-peroxy)hexyne-3 (DYBP), dicumyl-peroxide (DCUP), di-tert.-butyl-peroxide (DTBP), tert.-butyl-cumyl-peroxide (BCUP), bis(tert.-butylperoxyisopropyl)ben ene (DIPP), 3,6,9-triethyl-3,6,9-trimethyl-1,4,7-triperoxonane, di(tert-butylperoxyisopropyl)benzene, dicetyl peroxydicarbonate, or tert-butyl monoperoxymaleate.

6. The method according to claim 1, comprising:
adding the radical initiator to the polymeric material in an amount of 0.0001 to 5% by weight.

7. The method according to claim 1, comprising:
adding the thiourethane to the polymeric material in an amount of 0.0001 to 5% by weight.

8. The method according to claim 1, where R^{a} is based on an organic isocyanate, which is a cyclohexyl diisocyanate, methylenebis(cyclohexyl) diisocyanate, isophorone diisocyanate, phenyl diisocyanate, diphenylmethane diisocyanate or naphthyl diisocyanate, each of which is unsubstituted or substituted by a C₁-C₄ alkyl or di(C₁-C₄alkyl)amino, or is a C₄-C₂₀ alkyl diisocyanate, or an oligomeric or polymeric product obtained by reaction of above diisocyanates with themselves and/or with a polyol.

9. The method according to claim 1, where R^{a} is based on an organic isocyanate, which is a phenyl diisocyanate, which is unsubstituted or substituted by a C₁-C₄ alkyl, or an oligomeric or polymeric product obtained by reaction of the above diisocyanates with themselves and/or with a polyol.

10. The method according to claim 8, where the polyol is a C₁-C₁₀ alkanol comprising two or more hydroxy groups, or a poly-C₂-C₁₀ alkylene glycol.

11. The method according to claim 1, where R^{b} is a C₈-C₄₀ alkyl which is uninterrupted or interrupted by —O— and/or a carbonyl group.

12. The method according to claim 1, where the thiourethane is of formula (9) or (10) 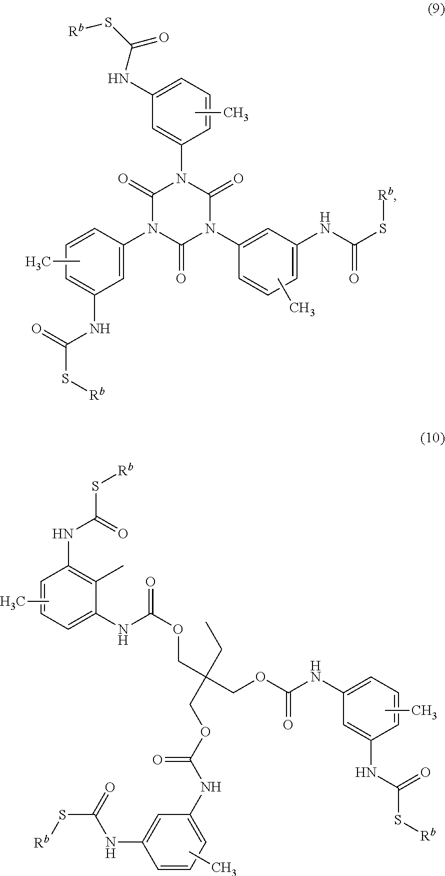
wherein R^{b} is a C₂-C₄₀ alkyl which is optionally substituted and/or interrupted.

13. The method according to claim 1, where the polymeric material is a thermoplastic polymer.

14. A modified polymeric material obtainable by incorporating in the polymeric material as defined in claim 13 a modifier blend, where the modifier blend comprises
a) a radical initiator selected from a group consisting of a peroxide, a carbon-based radical generator, a bis-azo compound, and a stable nitroxyl compound, and
b) a thiourethane of formula (1) 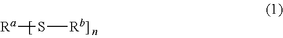
where
R^{a} is based on an organic isocyanate,
at least one radical —S—R^{a} is introduced by reaction with an isocyanate group,
R^{b} is a C₂-C₄₀ alkyl which is optionally substituted and/or interrupted, and
n is equal to or greater than 1.

15. A modifier blend as defined in claim 14, the modifier blend comprising:
a) a radical initiator selected from a group consisting of a peroxide, a carbon-based radical generator, a bis-azo compound, or a stable nitroxyl compound, and
b) a thiourethane of formula (1) 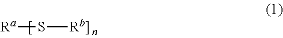
where
R^{a} is based on an organic isocyanate,
at least one radical —S—R^{a} is introduced by reaction with an isocyanate group,
R^{b} is a C₂-C₄, alkyl which is optionally substituted and/or interrupted, and
n is equal to or greater than 1.

16. The method according to claim 1, where the weight ratio of the radical initiator to the thiourethane is from 1:1 to 20:1.

17. The method according to claim 1, where the weight ratio of the radical initiator to the thiourethane is from 1,5:1 to 5:1.

18. The method according to claim 1, where the polymeric material is a linear low density polyethylene, low density polyethylene, medium density polyethylene, high density polyethylene, polyethylene copolymer, polypropylene homopolymer, or polypropylene copolymer.
